(19) United States
(12) Patent Application Publication
(10) Pub. No.: US 2008/0172359 A1
(43) Pub. Date: Jul. 17, 2008

(54) METHOD AND APPARATUS FOR PROVIDING CONTEXTUAL SUPPORT TO A MONITORED COMMUNICATION

(75) Inventors: Louis J. Lundell, Buffalo Grove, IL (US); Jason N. Howard, Alpharetta, GA (US); Thomas J. Weigert, Palatine, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/622,287

(22) Filed: Jan. 11, 2007

(51) Int. Cl. G06F 7/06; G10L 15/26; G10L 15/00

(52) U.S. Cl. 707/3; 704/251; 704/235; 704/E15.043; 707/E17.014

(57) ABSTRACT

A system [100] includes a database [130] to store a user profile for a user [140]. The user profile contains user-specific information. An intelligent agent [120] monitors a conversation involving the user for at least one keyword. In response to detecting the at least one keyword, the intelligent agent: (a) searches the user profile for at least one item corresponding to the at least one keyword; (b) retrieves the at least one item from the user profile; and (c) determines a relevance between the at least one keyword and the at least one item. An application communication element [135] communicates application information corresponding to the at least one item to an application program in response to the relevance exceeding a predetermined threshold.

### TECHNICAL FIELD

This invention relates generally to conversation analysis systems.

### BACKGROUND

Many people frequently participate in telephone calls and/or videoconference calls involving a variety of subjects. Sometimes it is known beforehand that a certain subject matter is going to be discussed in the phone call. For example, in a business setting, it may be known prior to the call that the director of marketing is going to discuss marketing strategies with an executive at the company. There are times when subjects are discussed in a conversation that were not previously scheduled. For example, a call between an attorney and a client might result in the attorney agreeing to fly to the client's place of business for a meeting.

Business people sometimes use assistants or secretaries to schedule reminders for such meetings. Such business people sometimes dictate instructions regarding such meetings and/or preparations for the meetings to the assistants/secretaries or write the instructions down on a piece of paper. Unfortunately, however, there is a possibility of human error in such interactions. For example, there is a possibility that an assistant who is in the process of adding a reminder message to a lawyer's interactive calendar will be interrupted to perform a different, but more urgent matter, and will inadvertently neglect to go back and finish adding the reminder to the calendar after the urgent matter has been completed.

Moreover, in the event that a new assistant is hired to work with the lawyer, there is a possibility that the new assistant will not be familiar with certain protocols. For example, if the lawyer requests the assistant to make arrangements for the lawyer to fly to Japan to meet with a client, the assistant may not know that he/she should check with the lawyer to ensure that the lawyer's passport has not expired.

There are systems in the art for providing tailored advertisements to an audience based on a user profile that the user has manually provided. For example, a person viewing a website may have manually filled out a profile when signing up for access to that web page, such as an online news service website. Accordingly, whenever the user comes back to the website, advertising is generated for the user based on the user's profile. Other systems in the art generate or modify a user's profile based on the type of items that the user has purchased from the website in the past. For example, if the user has purchased two action digital video discs (DVD) movies from an online website, the user's profile may be modified to generate and display advertisements corresponding to this shopping preference so that the next time the user clicks on that website, advertising for action movies similar to the ones already purchased will be displayed to the user.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a system according to at least one embodiment of the invention;

FIG. 2 illustrates an intelligent agent according to at least one embodiment of the invention;

FIG. 3 illustrates a method for providing contextual support to a monitored conversation according to at least one embodiment of the invention; and

FIG. 4 illustrates a system according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a method and system is provided for monitoring a conversation for the occurrence of certain keywords and performing some other related action based on the keywords and the context of the conversation. The conversation may be an audible conversation, such as one between two or more people using mobile stations (such as cellular telephones), hard-wired telephones, or any other type of communications device capable of transmitting and receiving voice information. Alternatively, the conversation may be a text-based conversation, such as an Instant Messaging conversation. In some embodiments, the conversation is analyzed substantially in real-time. In other embodiments, the conversation is stored after it has ended and is subsequently analyzed. In additional embodiments, the conversation may involve only a single person talking to, for example, a dictation machine.

As used herein, “keywords” can refer to an individual word, a portion of a word, and/or a combination of words in a particular order or grouping. The keywords may be automatically determined based on repeated sound bites or stressed sound bites that are detected within the conversation. Alternatively, certain keywords may already be known before the conversation takes place. For example, it may be known that that the words “2005 marketing presentation” or “CDMA-2000” are keywords. The keywords may be automatically determined based on analysis of previous conversations or the previous use of certain documents by a participant in the conversation. By analyzing conversations, important keywords may be determined and a prediction may be made as to whether those keywords are likely to be used again in future conversations. Alternatively, a given user may manually select appropriate keywords prior to engaging in the conversation.

An intelligent agent may “listen” to the conversation to detect an occurrence of the keywords. The intelligent agent may be a software module that analyzes the audio or text-based communication for occurrences of the keywords. For example, the intelligent agent may be implemented within a communication device utilized by one of the participants of the conversation. In the event that the user is utilizing a cellular telephone, the intelligent agent may be included in that user's cellular telephone. Alternatively, the communication device for each participant may include their own intelligent device. Also, in the event that the user has both a cellular telephone and a Personal Digital Assistant (PDA), and the cellular telephone is in communication with a wireless network via normal wireless methods, the cellular telephone may also be in communication with the PDA via, for example, a hard-wired direct connection or a short-range wireless transmission method such as Bluetooth™.

If desired, the intelligent agent may be remotely located and may analyze the audio and/or text of the conversation. For example, the intelligent agent may be in direct communication with the wireless network, or some other network or the Internet, to monitor, in whole or in part, the conversation.

The intelligent agent may be selectively initiated. For example, the user may be required to manually press a button or enter an instruction to launch the intelligent agent to start monitoring a conversation. Alternatively, the intelligent agent may automatically launch itself For example, if it is known that workers have to finish a time-sensitive project, the intelligent device may automatically launch itself during conversations taking place near the time deadline.

The communication agent may be in communication with a database. The database may be local to the intelligent agent. For example, in the event that the intelligent agent is implemented by a software module of a PDA, the database may be stored in a memory of the PDA. Alternatively, a hard-wired connection may exist between the intelligent agent and the database. In at least one other approach, the intelligent agent is in communication with the database via a wireless connection and/or via a network such as the Internet.

The database may include one or more user profiles. Each user profile contains information specific to a user. For example, a user profile may contain the user's birth date, passport expiration date, attorney state bar registrations, and credit card account information in addition to other user-specific information.

The intelligent agent includes a logic engine. Alternatively, the logic engine may be external to the intelligent agent. The logic engine determines relevance for the retrieved items based on a comparison between the detected keyword(s) and items in the user profile. The user profile may be determined based on previous conversations for the user and/or manual entries by the user. A conversation profile may also be utilized in determining the relevance of the items. The conversation profile is determined based on an analysis of the conversation. For example, if certain keywords occur a substantial number of times within a monitored conversation, the logic engine may determine those keywords to be more important than other keywords that occur less often.

If the relevance of the retrieved items exceeds a threshold relevance level or amount, the retrieved items are sent to an application communication element. The application communication element transmits application items to one or more application programs. The application items correspond to the relevant items retrieved from the user profile. For example, the application items may instruct a calendar program to reflect that a meeting is scheduled for a particular day or that the user's passport needs to be renewed.

These teachings therefore provide functionality to enhance interpersonal communication by automatically locating items corresponding to certain keywords within a conversation. Such teachings eliminate the need for a person to manually update a calendar him or herself, or add reminders to a calendar program, allowing the person to work more efficiently.

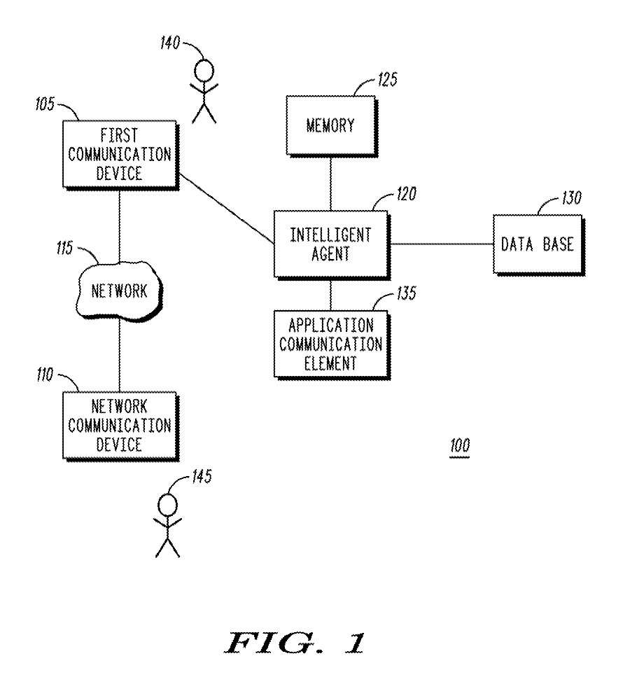

FIG. 1 illustrates a system 100 according to at least one embodiment of the invention. As shown, the system 100 includes a first communication device 105, a second communication device 110, a network 115, an intelligent agent 120, a memory 125, a database 130, and an application communication element 135. Either or both of the first communication device 105 and the second communications device 110 may comprise a telephone, a mobile communications device (such as a cellular telephone), a PDA, a mobile communications device in communication with a PDA, a computer, or any other suitable electronic device. The first communication device 105 and the second communication device 110 may each comprise any type of communications device capable of transmitting and receiving audio and/or text as part of a conversation. A first user 140 may utilize the first communication device 105 and a second user 145 may utilize the second communication device 110.

The first communication device 105 may be in communication with the second communication device 110 via a network 115. The network 115 may comprise a Local Area Network (LAN), a Wide Area Network (WAN), the Internet, or any other type of network for transporting audio and/or text. In an alternative embodiment, the first communication device 105 is in direct communication with the second communication device 110, in which case the network 115 may not be necessary.

As shown, the intelligent agent 120 is in communication with the first communication device 105 to monitor the audio and/or text being transmitted back and forth between the first communication device 105 and the second communication device 110 as part of a conversation. Although only shown as being in communication with the first communication device 105, it should be appreciated that the intelligent agent 120 could instead be in communication with only the second communication device 110. Moreover, there may be a second intelligent agent to communicate with the second communication device 110 such that each of the first communication device 105 and the second communication device 110 are in direct communication with their own respective intelligent agent.

The intelligent agent 120 is in communication with the database 130. The intelligent agent 120 monitors the conversation between the first communication device 105 and the second communication device 110 for certain keywords, as discussed above. When keywords are detected, the intelligent agent 120 accesses a user profile for the first user 140. The user profile for the first user 140 is stored within the memory 125. The user profile may include various information specific to a user. For example, the user profile may contain the user's birth date, passport expiration date, attorney state bar registrations, credit card account information, and other user-specific information as desired. If desired, it would also be possible for the user profile to include information that, while not necessarily specific to a given individual, is specific to a group to which the user belongs. To illustrate, when the user comprises a physician, this can lead, in turn, to including information in the user profile that is generally specific to physicians even though not necessarily known to be specifically applicable to this particular individual.

Upon detecting keywords, the user profile is searched for associated information. For example, in the event that the keywords “Japanese business trip” are detected, the intelligent agent 120 accesses the user profile for associated information. For example, the user profile might contain information such as the expiration date of the first user's 140 passport, as well as the first user's 140 airline frequent flyer number. Upon locating such items or information in the memory 125, such items are retrieved. The intelligent agent 120 may implement a logical reasoning application or logic engine to determine which of the located information is most relevant to the detected keywords. For example, items pertaining to the user's favorite fishing spot in the summer in Japan may not be relevant to a business trip occurring during the winter months.

Upon retrieving the items, the intelligent agent 120 communicates with an application communication element 135. The application communication element 135 transmits application items to one or more application programs. The application items correspond to the items retrieved from the user profile. For example, in the event that the “Japanese business trip” keywords are detected and the user profile indicates that the first user's passport is going to expire, the application communication element 135 may update a calendar application program with an entry to indicate that the first user's passport needs to be renewed. The application communication element 135 may also indicate a deadline by which the passport must be renewed. Other information may also be updated. For example, if the user profile indicates that the user is allergic to tuna sushi, the application communication element 135 may update the calendar to indicate that the Japanese client should be informed as to the first user's 140 allergy so that tuna sushi is not served to the first user 140 during the business trip.

The intelligent agent 120 therefore acts much like a human secretary or assistant in terms of performing certain tasks such as updating the first user's 140 calendar. There are other types of application that may be updated or modified by the application communication element 135. For example, the application communication element 135 may generate an e-mail to send to a travel agent to request that airline tickets be purchased upon detecting the “Japanese business meeting” keywords. The e-mail to the travel agent may indicate the first user's identity, the date of the trip, the first user's food preferences and frequently flyer number, as well as various other flight preferences such as whether the first user prefers non-stop flights, an aisle seat, and/or day or night flights.

Alternatively, the application communication element 135 may directly book the flight for the first user. For example, the application communication element may automatically log into an airline website or some other website for purchasing airline tickets and may fill in the appropriate dates of the flight and the first user's meal and seat preferences. In some embodiments, the entire reservation is made automatically. In other embodiments, the first user or the first user's assistant or secretary is required to review the airline ticket information provided by the application communication element 135 and then click a button or confirm the information in some other way.

Accordingly, the intelligent agent 120 serves to enhance a conversation by providing context to the conversation and performing certain tasks related to the keywords detected in the conversation. Such use of the intelligent agent provides for a more efficient way of performing such tasks and effectively removes the human element which could make errors or neglect to do something.

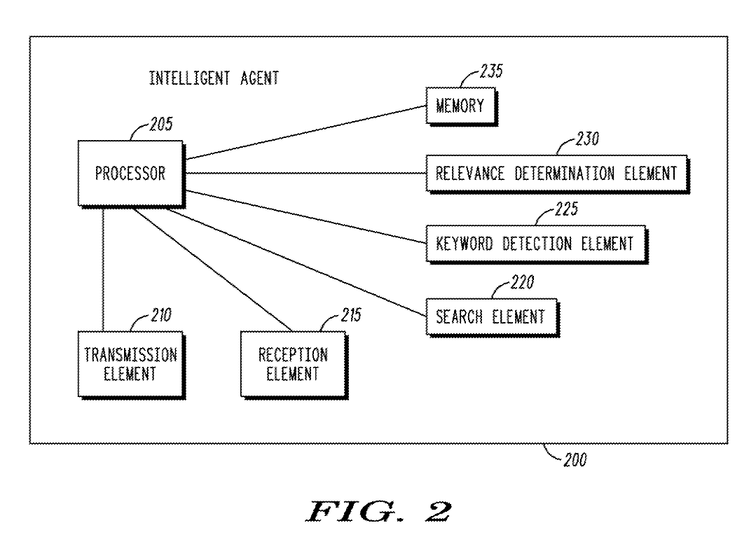

FIG. 2 illustrates an intelligent agent 200 according to at least one embodiment of the invention. As shown, the intelligent agent 200 includes a processor 205, a transmission element 210, a reception element 215, a search element 220, a keyword detection element 225, a relevance determination element 230 and a memory 235. In some embodiments, a single transceiver may be utilized instead of a separate transmission element 210 and reception element 215.

The reception element 215 acquires the audio and/or text data transmitted during the conversation between, for example, the first communication device 105 and the second communication device 110 shown in FIG. 1. The processor 205 analyzes the audio and/or text for the presence of the keywords. The keywords may be individual words, portions of words, and/or a combination of words in a particular order or grouping. The keywords may be automatically determined based on repeated sound bites or stressed sound bites that are detected within the conversation. For example, during the conversation one of the speakers may utilize a different pitch, tone, or volume level when speaking certain words that are critical to the conversation.

The speakers may also repeat certain words throughout the conversation that are important to the conversation. For example, if the words “CDMA-2000” are repeated 15 times, for example, during a three-minute conversation, it may be inferred that CDMA-2000 is a keyword based on this higher than normal repetition. Alternatively, certain keywords may already be known before the conversation takes place. For example, it may be known that that the words “2005 marketing presentation,” or “CDMA-2000” are keywords.

The memory 235 may hold program code to be executed by the processor 205. The keyword detection element 225 is utilized to monitor the conversation to detect the keywords. Upon detecting one or more of the keywords, the search element 220 searches the user's profile for items corresponding to the keywords, as discussed above with respect to FIG. 1. Upon detecting corresponding items, such items are retrieved and analyzed by the relevance determination element 230 that determines relevance between the retrieved items and the detected keywords. The relevance determination element 230 may implement a logic routine or application program that measures the relevance. The measured relevance is matched against a predetermined relevance threshold and, upon exceeding the threshold, a determination is made that the retrieved items are relevant. The transmission element 210 subsequently sends the relevant retrieved items to the application communication element 135 discussed above with respect to FIG. 1.

The application communication element 135 notifies the appropriate application programs as to various actions or updates that are to take place regarding, for example, scheduling and reservations or other related actions to implement.

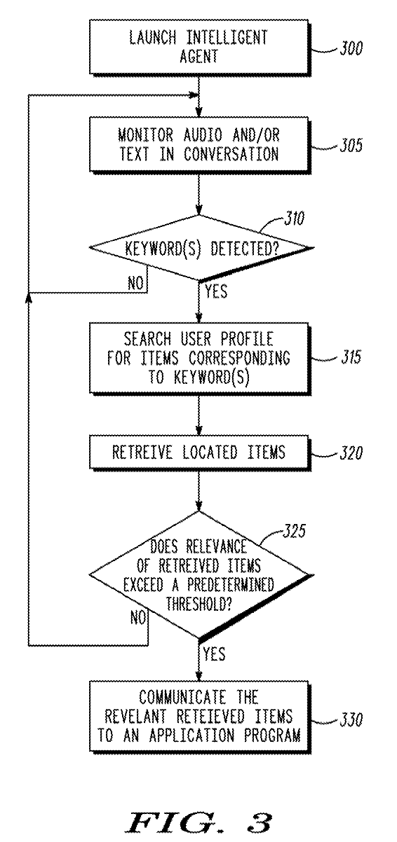

FIG. 3 illustrates a method for providing contextual support to a monitored conversation according to at least one embodiment of the invention. First, at operation 300, the intelligent agent, such as the intelligent agent 120 shown in FIG. 1 or the intelligent agent 200 shown in FIG. 2, is launched. Next, the audio and/or text in a conversation is monitored at operation 305. When audio is monitored, the audio may be received by a microphone in combination with a processor or other device that converts the audio into text or some other format suitable for processing. At operation 310 a determination is made regarding whether one or more keywords are detected. If “no,” processing returns to operation 305. If “yes,” processing proceeds to operation 315 where the user's profile is searched for items corresponding to the one or more detected keywords. As discussed above with respect to FIG. 1, the user profile may be stored in memory 125.

In the event that any corresponding items are found in the user profile, such items are retrieved at operation 320. Next, a determination is made at operation 325 regarding whether the relevance of the retrieved items exceeds a predetermined threshold. If “no,” processing returns to operation 305. If “yes,” on the other hand, processing proceeds to operation 330 at which point the application items corresponding to the relevant retrieved items are communicated to an application program. The application communication element 135 shown in FIG. 1 may perform this communicating operation. The application items may instruct an application program to perform an operation, such as updating a calendar program.

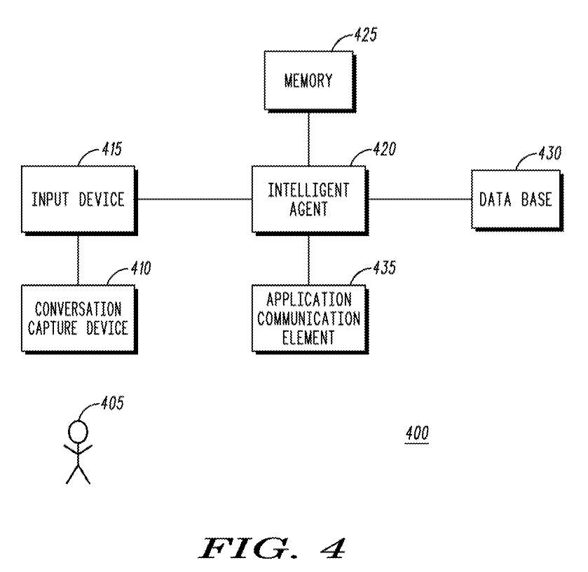

FIG. 4 illustrates a system 400 according to at least one embodiment of the invention. As shown, the system 400 includes a conversation capture device 410, an input device 415, an intelligent agent 420, a memory 425, a database 430, and an application communication element 435. The system 400 may be utilized by a user 405. The user 405 may speak and the conversation capture device 410 captures the audio and converts it into text or some other suitable format. The system 400 shown in FIG. 4 differs from the system 100 shown in FIG. 1 in that the conversation being detected only involves a single user 405 whose voice is detected and captured by the conversation capture device 410. Alternatively, the user may type keywords, text, or upload a pre-recorded conversation directly to the input device 415.

The input device 415 provides the appropriate conversation or other information to the intelligent agent 420. The intelligent agent 420 analyzes the data or conversation information provided by the input device 415 for keywords. Upon detecting one or more keywords, the intelligent agent 420 refers to a user profile stored in the database 430 for items associated with the detected keywords. Upon locating such items, the items are retrieved and analyzed to determine their relevance. If the relevance exceeds a predetermined threshold level, they are sent to the application communication element 435 which then forwards associated application items to the appropriate applications. The appropriate applications to be contacted may be determined by the intelligent agent 420 or may instead be directed directly by the application communication element 435.

So configured, those skilled in the art will recognize and appreciate that a conversation between two or more participants can be greatly enhanced through the use of an intelligent agent that has an ability to perform certain routine functions such as updating a calendar to reflect due dates or items scheduled for a particular day. The intelligent agent may also transmit e-mail communications or contact other application programs to perform other tasks. By automatically detecting keywords and associated functions to be performed based on a comparison of a user profile to the detected keywords, efficiencies are realized and a reliable system is provided for performing routine functions. These teachings are highly flexible and can be implemented in conjunction with any of a wide variety of implementing platforms and application settings. These teachings are also highly scalable and can be readily utilized with almost any number of participants.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As but one example in this regard, these teachings will readily accommodate using speaker identification techniques to identify a particular person who speaks a particular keyword of interest. In such a case, the follow-on look-up activities can be directed to (or limited to) particular applications relating to the particular person that have been previously related to that particular person. In this case, the retrieved content would be of particular relevance to the keyword speaker. As another example in this regard, a given participant can be given the ability to disable this feature during the course of a conversation if that should be their desire.

We claim:

1. A system, comprising:
a database to store a user profile of a user, the user profile containing user-specific information;
an intelligent agent to monitor a conversation involving the user for at least one keyword, wherein in response to detecting the at least one keyword, the intelligent agent:
searches the user profile for at least one item corresponding to the at least one keyword;
retrieves the at least one item from the user profile; and
determines a relevance between the at least one keyword and the at least one item; and
an application communication element to communicate application information corresponding to the at least one item to an application program in response to the relevance exceeding a predetermined threshold.

2. The system of claim 1, wherein in the intelligent agent comprises a keyword detection element to detect the at least one keyword based on a detection of at least one of: repeated sound bites and stressed sound bites.

3. The system of claim 1, wherein the intelligent agent comprises a search element to search the user profile.

4. The system of claim 1, wherein the application comprises a scheduling program to indicate the user's schedule for a designated time period.

5. The system of claim 1, wherein the application information comprises deadline-specific information.

6. The system of claim 1, further comprising a user input device to provide input from the user to generate the user profile.

7. A method, comprising:
monitoring a conversation involving the user for at least one keyword;
searching the user profile for at least one item corresponding to the at least one keyword and retrieving the at least one item in response to detecting the at least one keyword;
determining a relevance between the at least one keyword and the at least one item; and
communicating application information corresponding to the at least one item to an application program in response to the relevance exceeding a predetermined threshold.

8. The method of claim 7, further comprising detecting the at least one keyword based on a detection of at least one of repeated sound bites and stressed sound bites.

9. The method of claim 7, wherein the application comprises a scheduling program to indicate the user's schedule for a designated time period.

10. The method of claim 7, further comprising updating the application with deadline-specific information.

11. The method of claim 7, further comprising receiving a user input from the user to generate the user profile.

12. The method of claim 7, wherein the application program is selected by an intelligent agent.

13. A system, comprising:
an input device to receive an input comprising at least one keyword;
a database to store a user profile a user, the user profile containing user-specific information;
an intelligent agent to detect the at least one keyword in the input, wherein in response to detecting the at least one keyword, the intelligent agent:
searches the user profile for at least one item corresponding to the at least one keyword;
retrieves the at least one item from the user profile; and
determines a relevance between the at least one keyword and the at least one item; and
an application communication element to communicate application information corresponding to the at least one item to an application program in response to the relevance exceeding a predetermined threshold.

14. The system of claim 13, wherein the intelligent agent comprises a keyword detection element to detect the at least one keyword based on a detection of at least one of repeated sound bites and stressed sound bites in the input.

15. The system of claim 13, wherein the intelligent agent comprises a search element to search the user profile.

16. The system of claim 13, wherein the application comprises a scheduling program to indicate the user's schedule for a designated time period.

17. The system of claim 13, wherein the application information comprises deadline-specific information.

18. The system of claim 13, further comprising a conversation capture device to detect audio from the user, convert the audio into data, and transmit the data to the input device.
